(19) United States
(12) Patent Application Publication
(10) Pub. No.: US 2024/0338870 A1
(43) Pub. Date: Oct. 10, 2024

(54) GENERATIVE AI BASED TEXT EFFECTS WITH CONSISTENT STYLING

(71) Applicant: ADOBE INC., SAN JOSE, CA (US)

(72) Inventors: Siddharth Iyer, San Francisco, CA (US); David Davenport Bourgin, Brooklyn, NY (US); Sudeep Katakol, San Francisco, CA (US); Aliakbar Darabi, Newcastle, WA (US)

(21) Appl. No.: 18/479,379

(22) Filed: Oct. 2, 2023

Related U.S. Application Data
(60) Provisional application No. 63/495,194, filed on Apr. 10, 2023.

(51) Int. Cl. G06T 11/60

(52) U.S. Cl. CPC G06T 11/60; G06T 2200/24

(57) ABSTRACT

A method, apparatus, and non-transitory computer readable medium for image generation are described. Embodiments of the present disclosure obtain, via a user interface, an input text. The user interface also obtains a text effect prompt that describes a text effect for the input text. An image generation model generates an output image depicting the input text with the text effect described by the text effect prompt.

### CROSS-REFERENCE TO RELATED APPLICATION

This application claims benefit under 35 U.S.C. § 119 of U.S. Provisional Application No. 63/495,194, filed on Apr. 10, 2023, in the United States Patent and Trademark Office, the disclosure of which is incorporated by reference herein in its entirety.

### BACKGROUND

The following relates generally to image processing, and more specifically to generating and applying text effects using machine learning. Image processing refers to the use of a computer to edit a digital image using an algorithm or a processing network. Recently, machine learning models have been used in advanced image processing techniques. Among these machine learning models, diffusion models and other generative models such as generative adversarial networks (GANs) have been used for various tasks including generating images with perceptual metrics, generating images in conditional settings, image inpainting, and image manipulation.

Image generation, a subfield of image processing, includes the use of diffusion models to synthesize images. Diffusion models can be used for various image generation tasks including image super-resolution, generation of images with perceptual metrics, conditional generation (e.g., generation based on text guidance), image inpainting, and image manipulation. Specifically, diffusion models are trained to take random noise as input and generate unseen images with features similar to the training data. In some examples, text effects include visual effects applied to text including effects other than the shape or outline of the text (i.e., the font).

### SUMMARY

The present disclosure describes systems and methods for image generation. Embodiments of the present disclosure include an image processing apparatus configured to obtain an input text, a text effect prompt, and one or more styling parameters as input and generate an output image using an image generation model. The image processing apparatus generates a mask for each character of the input text and is trained to generate the output image based on the mask. The output image depicts the input text with the text effect specified in the text effect prompt. For example, the text effect prompt further includes a description of style (e.g., “pebble”), an aesthetic prompt (e.g., “style=watercolor”), and a negative prompt (e.g., “avoid=yellow”) that are applied to the input text (e.g., “ABC”). In some examples, the one or more styling parameters include at least text effect fit parameter, font, background color, text color, etc.

A method, apparatus, and non-transitory computer readable medium for image processing are described. One or more embodiments of the method, apparatus, and non-transitory computer readable medium include obtaining, via a user interface, an input text; obtaining, via the user interface, a text effect prompt that describes a text effect for the input text; and generating, by an image generation model, an output image depicting the input text with the text effect described by the text effect prompt.

A method, apparatus, and non-transitory computer readable medium for image processing are described. One or more embodiments of the method, apparatus, and non-transitory computer readable medium include initializing an image generation model; receiving training data including a training input text, a training image depicting the training input text, and a training text effect prompt that describes a text effect for the training input text; generating a mask for each character of the training input text; and training the image generation model to generate an output image based on the mask, wherein the output image comprises the text effect based on the training text effect prompt.

An apparatus and method for image processing are described. One or more embodiments of the apparatus and method include at least one processor; at least one memory including instructions executable by the at least one processor; a text interface configured to obtain an input text; a prompt interface configured to obtain a text effect prompt that describes a text effect for the input text; and an image generation model comprising parameters stored in the at least one memory and trained to generate an output image depicting the input text with the text effect based on the text effect prompt.

### BRIEF DESCRIPTION OF THE DRAWINGS

FIG. 1 shows an example of an image processing system according to aspects of the present disclosure.

FIG. 2 shows an example of a method for image generation application according to aspects of the present disclosure.

FIG. 3 shows an example of a first text effect according to aspects of the present disclosure.

FIG. 4 shows an example of a second text effect according to aspects of the present disclosure.

FIG. 5 shows an example of a third text effect according to aspects of the present disclosure.

FIG. 6 shows an example of a fourth text effect according to aspects of the present disclosure.

FIG. 7 shows an example of a method for image processing according to aspects of the present disclosure.

FIG. 8 shows an example of an image processing apparatus according to aspects of the present disclosure.

FIG. 9 shows an example of a guided diffusion model according to aspects of the present disclosure.

FIG. 10 shows an example of U-Net architecture according to aspects of the present disclosure.

FIG. 11 shows an example of a machine learning model according to aspects of the present disclosure.

FIG. 12 shows an example of a diffusion process according to aspects of the present disclosure.

FIG. 13 shows an example of a text effect generation process according to aspects of the present disclosure.

FIG. 14 shows an example of a method for training a diffusion model according to aspects of the present disclosure.

FIG. 15 shows an example of a method for training an image generation model according to aspects of the present disclosure.

FIG. 16 shows an example of a computing device according to aspects of the present disclosure.

### DETAILED DESCRIPTION

The present disclosure describes systems and methods for image generation. Embodiments of the present disclosure include an image processing apparatus configured to obtain an input text, a text effect prompt, and one or more styling parameters as input and generate an output image using an image generation model. The image processing apparatus generates a mask for each character of the input text and is trained to generate the output image based on the mask. The output image depicts the input text with the text effect specified in the text effect prompt. For example, the text effect prompt further includes a description of style (e.g., “pebble”), an aesthetic prompt (e.g., “style=watercolor”), and a negative prompt (e.g., “avoid=yellow”) that are applied to the input text (e.g., “ABC”). In some examples, the one or more styling parameters include at least text effect fit parameter, font, background color, text color, etc.

Recently, users have used software applications to modify attributes related to text. For example, in a word editing application, users can change attributes such as font and text color. However, conventional tools are limited to applying sophisticated text effects or styles to text. These tools are often equipped with text effect presets and are limited in number and variations. Accordingly, content creators have to manually insert desired text effects to characters and the editing process is time consuming and not friendly to inexperienced editors.

Generative models produce text effects when combined with techniques like SDEdit and in-painting. However, some of these methods do not efficiently scale to multiple characters and struggle to generate multiple letters with consistent styling. Some methods that use a “prior” model can generate consistent text effect styling, but using the prior model alone results in poor quality generations with “cut-out” like effects.

Embodiments of the present disclosure include an image processing apparatus configured to obtain an input text, a text effect prompt, and one or more styling parameters and generate an output image depicting the input text with the target text effect specified in the text effect prompt using an image generation model. In some examples, the text effect prompt includes a description of style (e.g., “pebble”), an aesthetic prompt (e.g., “style=watercolor & black and white”), and a negative prompt (e.g., “avoid=yellow”). The one or more styling parameters include text effect fitness (i.e., a degree that the target text effect should respect the shape of the underlying font, e.g., “tight fit”, “medium fit”, “loose fit”), font, background color, text color, etc.

In some examples, the image processing apparatus takes the input text, the text effect prompt, and the styling parameters as inputs and generates the output image using a diffusion model. A text effect encoder of the image processing apparatus includes an aesthetic encoder configured to generate an aesthetic embedding and a style encoder configured to generate a style embedding. The output image is generated based on the aesthetic embedding and the style embedding.

In some examples, a user selects a font type as a starting point. The user enters their desired text using the selected font. The user chooses the degree to which the effects should adhere to the underlying font shape, with options including “tight,” “medium,” or “loose.” The user sets the background color to be either a single color or transparent. The user sets the text color to subtly influence the color of the resulting text effect. The user inputs a text effect prompt describing the desired styling to be applied to the text. After a short processing period, the text is rendered with the specified styles, with each character sharing a similar yet distinct styling. In some examples, characters or stylized letters in the output image have a consistent style, and the textures of the characters are not identical. The user then downloads the resulting image for integration into a project.

In some embodiments, the image processing apparatus receives input text and a text effect prompt. Also, the image processing apparatus obtains or generates a style prompt. The text effect prompt is used to describe the effect, while the style prompt is provided to the prior model to get the image embedding, which is then used to enforce styling and consistency of the generations. In some examples, the style prompt is hidden from the user.

The systems and methods of the present disclosure address the challenge of efficiently applying intricate, detailed, and visually interesting text effects, referred to as “Text Effects,” in a design workflow. Traditional approaches to creating text effects can be time-consuming, and generating effects that are similar in style but not identical while maintaining detail fidelity and visual interest can be particularly difficult. By utilizing the proposed method, designers quickly generate multiple detailed and consistent text effects, which can be used as is or as a starting point for further refinement. Additionally, embodiments of the present disclosure provide a fast and reliable approach for stylizing text while maintaining legibility and consistent styling. The generation creativity, text legibility, and stylization consistency are all highly controllable.

One or more embodiments include leveraging a generative model conditioned on both text and image embeddings. The image embedding, derived from a prior model similar to DALL-E, is used to achieve consistent styling. The contribution of the image embedding is removed for a certain percentage of the diffusion iterations to allow the model to be more creative and avoid “cut-out” like effects. The diffusion inference scheme alternates between including and excluding the image embedding to control stylization. The sampling iteration steps have been optimized to improve legibility without compromising quality. A combination of SDEdit and DiffEdit is employed to balance creativity and legibility. Also, prompt engineering has been optimized to bias generations towards visually appealing results.

In some examples, a mask or transparency can be generated after the style is applied to the glyph. Since the generated image may not conform to the precise boundaries of the initial text font, it can be useful to determine the boundaries of the foreground after generation. This can be useful to enable a user to apply the text to another background.

To obtain the mask or transparency of the foreground text including the text effects, a combination of methods may be applied. For example, a subject selection method, an object selection method, or a color-based selection method may be used to identify and differentiate foreground and background pixels. In some cases, a single boundary selection method is used, and in some cases, a combination of methods is applied. A distance transform may also be used to generate or refine a glyph boundary mask.

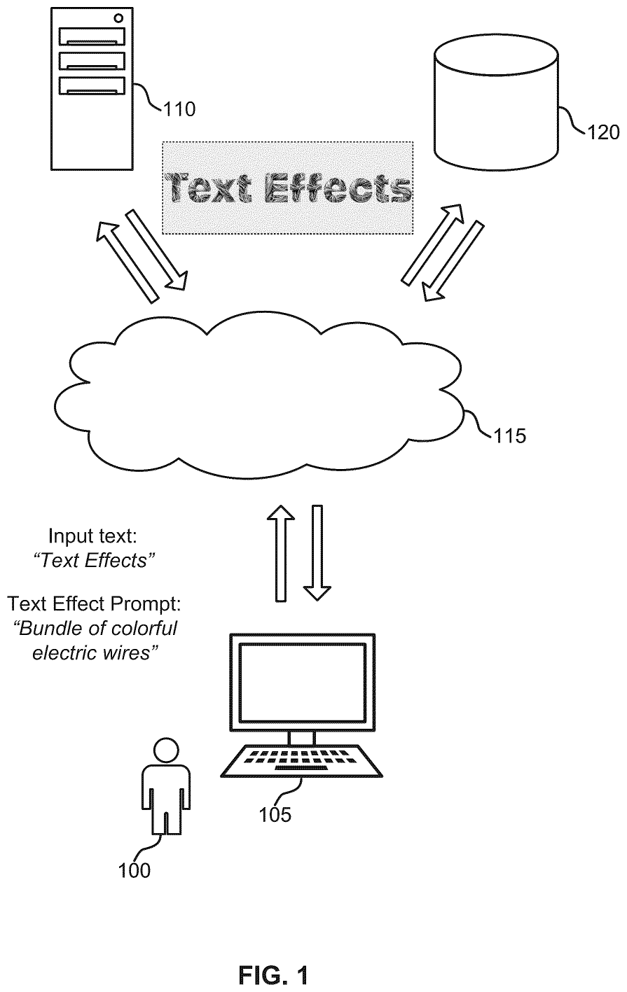

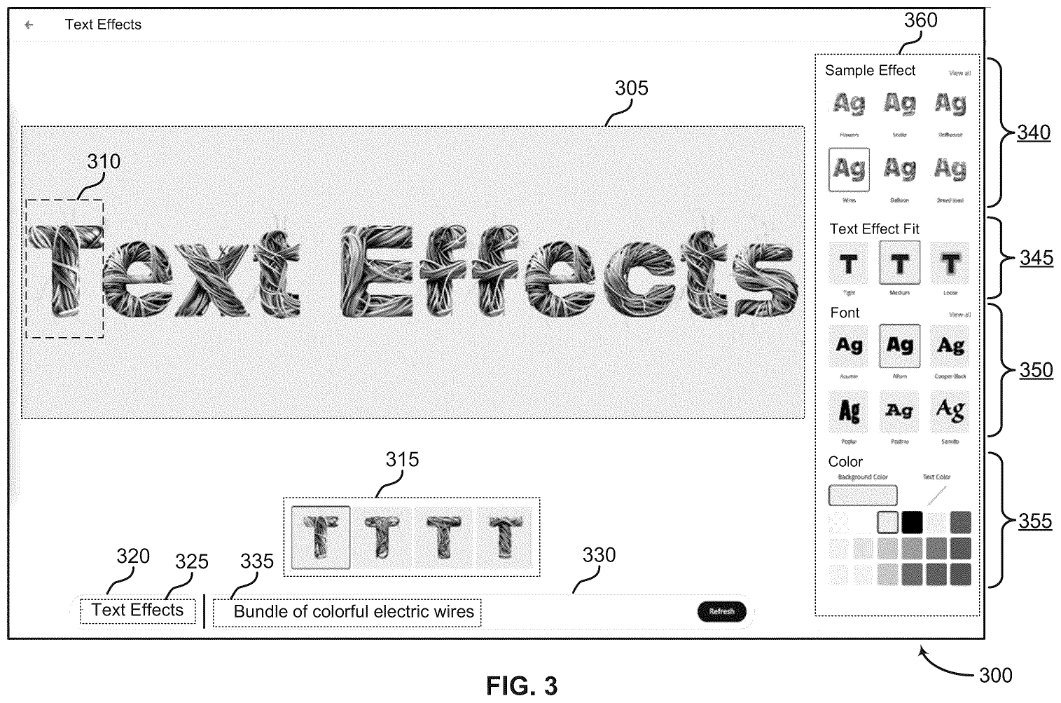

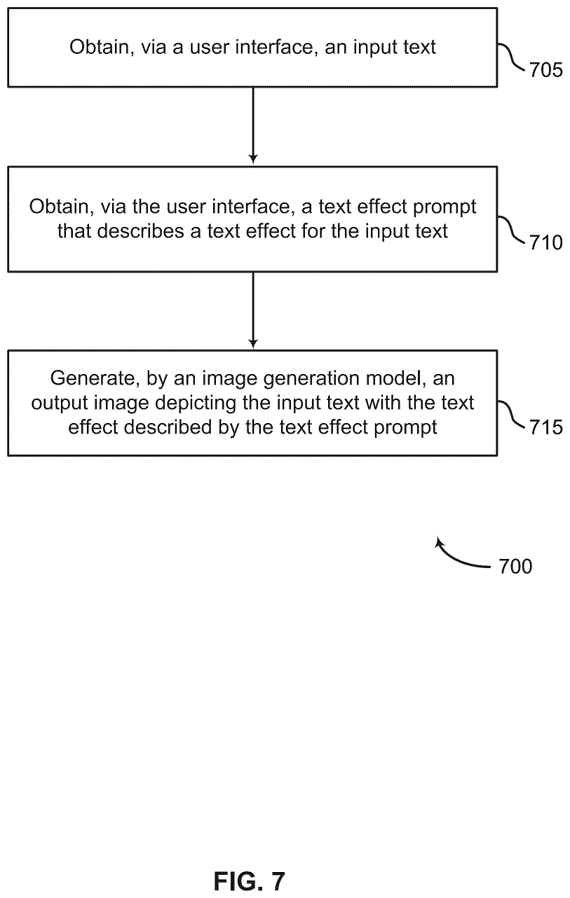

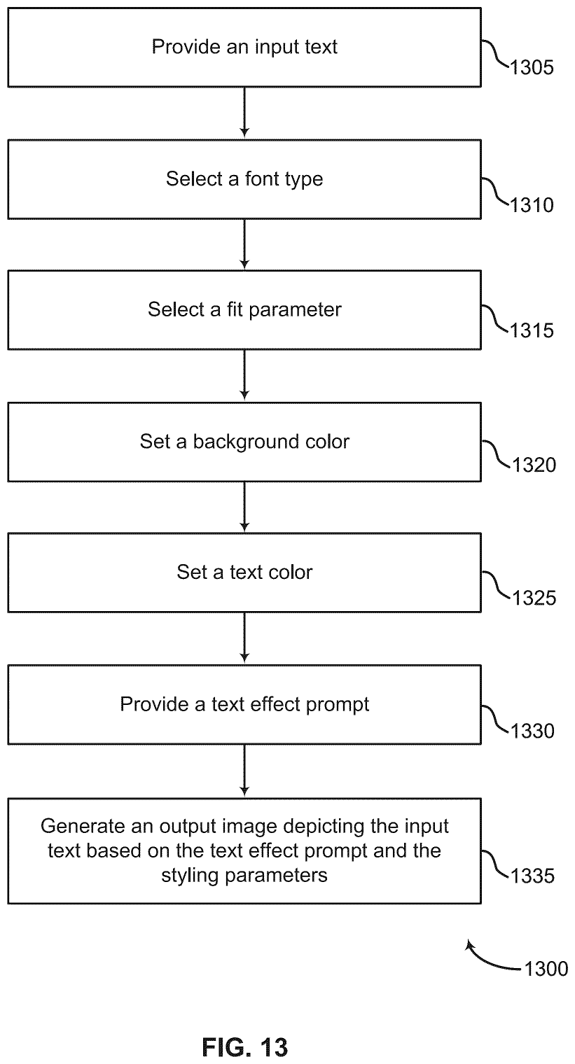

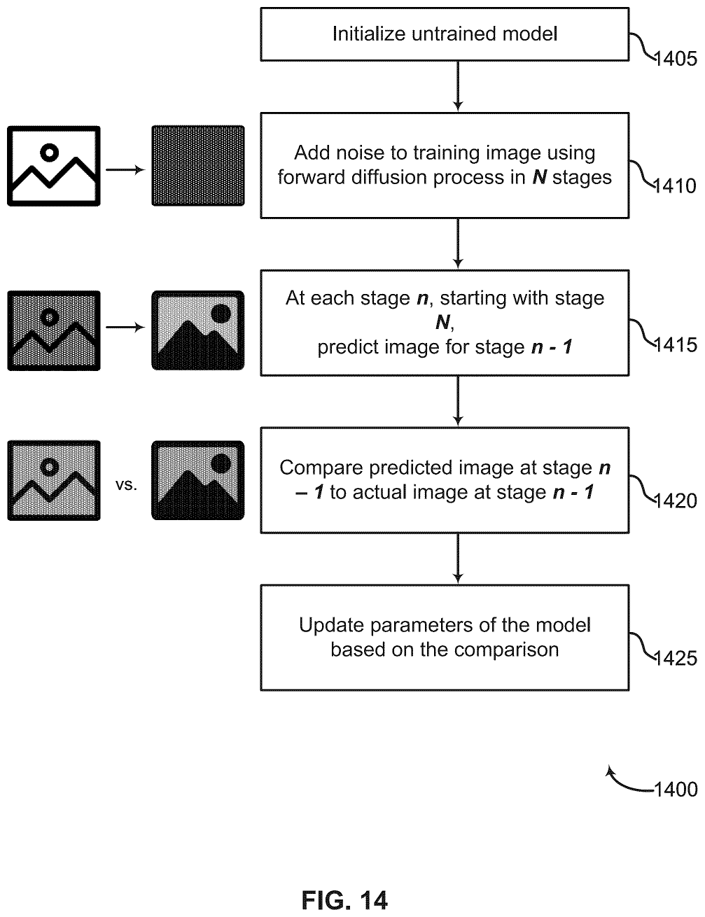

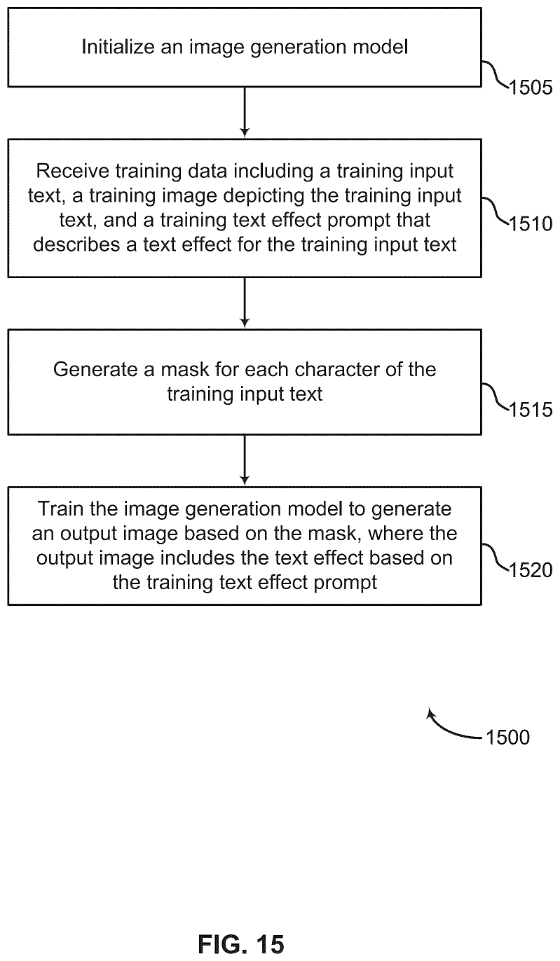

Embodiments of the present disclosure can be used in the context of image editing applications involving applying text effects. For example, an image processing apparatus based on the present disclosure obtains an input text, a text effect prompt, and one or more styling parameters and generates an output image applying the text effect prompt and the styling parameters to the input text. An example application in the image generation context is provided with reference to FIGS. 3-6. Details regarding the architecture of an example image processing system are provided with reference to FIGS. 1 and 8-12. Details regarding the process of image processing are provided with reference to FIGS. 7 and 13. Example training processes are described with reference to FIGS. 14-15.

Conventional models generate images with poor quality and “cut-out” like effects. These models fail to generate character images with consistent styling but slight variations. By contrast, the image processing apparatus based on the present disclosure applies text effect specified in a text effect prompt to a text prompt and generates high-quality images comprising one or more symbols or characters. The output image is excluded from “cut-out” like effects and character images in the output image have consistent style and these characters or symbols are of slight variations. For example, shapes of the characters in the output image may deviate from the shape of the underlying font.

Accordingly, by specifying desired text effects in text form and making one or more styling parameters for options, embodiments of the present disclosure provide a controllable generative model for applying text effects while maintaining text legibility and consistent styling across characters of text. Furthermore, the generation process involving text effects is faster and more reliable in a design workflow. Additionally, methods and apparatus of the present disclosure enable users to rapidly apply text effects, styles or textures onto an input text using a text effect prompt. The variety of text effect being applied to text is increased compared to conventional systems by leveraging pre-trained text-to-image generative models. In some cases, users have increased control over the generated results because users can specify a detailed text effect prompt to include a description of style (e.g., “pebble”), an aesthetic prompt (e.g., “style=watercolor”), and a negative prompt (e.g., “avoid=yellow”) that is then applied to an input text. Accordingly, a relatively diverse and appealing set of text effects are applied to input texts or symbols.

### Applying Text Effects to Image Generation

In FIGS. 1-7, a method, apparatus, and non-transitory computer readable medium for image processing are described. One or more embodiments of the method, apparatus, and non-transitory computer readable medium include obtaining, via a text interface, an input text; obtaining, via a prompt interface, a text effect prompt that describes a text effect for the input text; and generating, by an image generation model, an output image depicting the input text with the text effect described by the text effect prompt.

Some examples of the method, apparatus, and non-transitory computer readable medium further include identifying a font for the input text, wherein the output image is generated based on the font.

Some examples of the method, apparatus, and non-transitory computer readable medium further include identifying a fit parameter that indicates a degree to which the output image adheres to a shape of the input text, wherein the output image is generated based on the fit parameter.

Some examples of the method, apparatus, and non-transitory computer readable medium further include identifying a background color, wherein the output image is generated based on the background color.

Some examples of the method, apparatus, and non-transitory computer readable medium further include identifying a text color, wherein the output image is generated based on the text color.

Some examples of the method, apparatus, and non-transitory computer readable medium further include generating a mask for each character of the input text. Some examples further include generating a character image for each character of the input text based on the mask, wherein the output image includes the character image for each character of the input text.

Some examples of the method, apparatus, and non-transitory computer readable medium further include encoding the text effect prompt to obtain a text effect embedding, wherein the output image is generated based on the text effect embedding.

Some examples of the method, apparatus, and non-transitory computer readable medium further include obtaining, via a styling interface, one or more styling parameters, wherein the output image is generated based on the one or more styling parameters.

Some examples of the method, apparatus, and non-transitory computer readable medium further include generating a style embedding and an aesthetic embedding based on the text effect prompt, wherein the output image is generated based on the style embedding and the aesthetic embedding.

In some examples, the text effect prompt comprises a style tag and the style embedding is based on the style tag. Some examples of the method, apparatus, and non-transitory computer readable medium further include identifying at least a portion of the text effect prompt as a negative text. Some examples further include encoding the negative text to obtain a negative text effect embedding, wherein the output image is generated based on the negative text effect embedding.

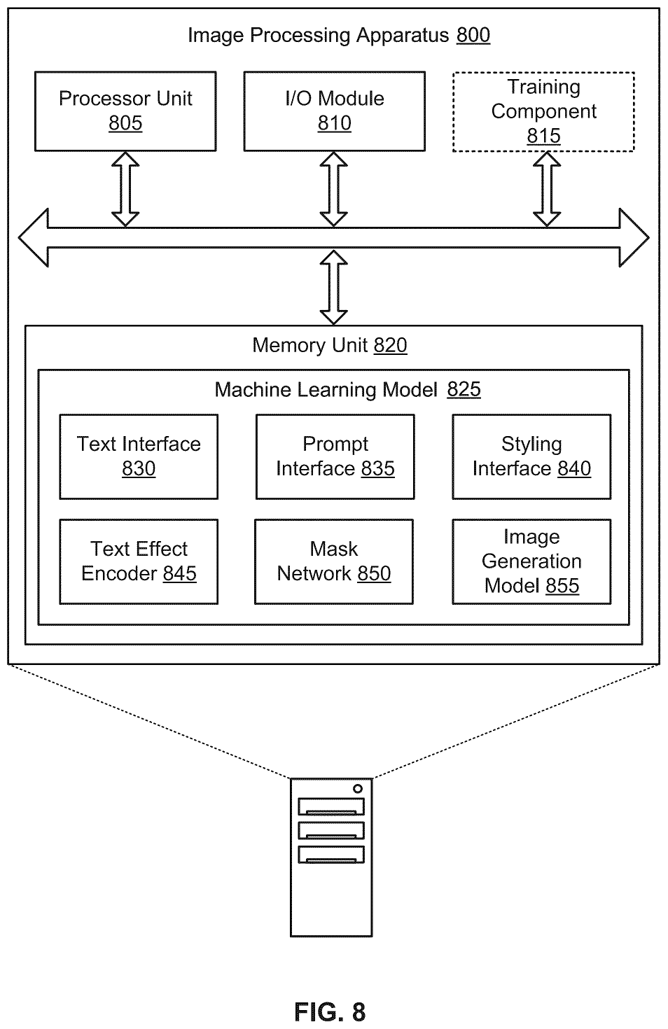

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 8.

In an example shown in FIG. 1, an input text and a text effect prompt are provided by a user 100 and transmitted to image processing apparatus 110, e.g., via user device 105 and cloud 115. Image processing apparatus 110 obtains, via a text interface, the input text. Image processing apparatus 110 obtains, via a prompt interface, the text effect prompt that describes a text effect for the input text. An image generation model (e.g., a pixel diffusion model) generates an output image depicting the input text with the text effect described by the text effect prompt. In the example, input text is “Text Effects” comprising a total of eleven English letters. Text effect prompt is “bundle of colorful electric wires”. The text effect prompt is applied to the letters or characters when generating the output image. Image processing apparatus 110 returns the output image to user 100 via cloud 115 and user device 105.

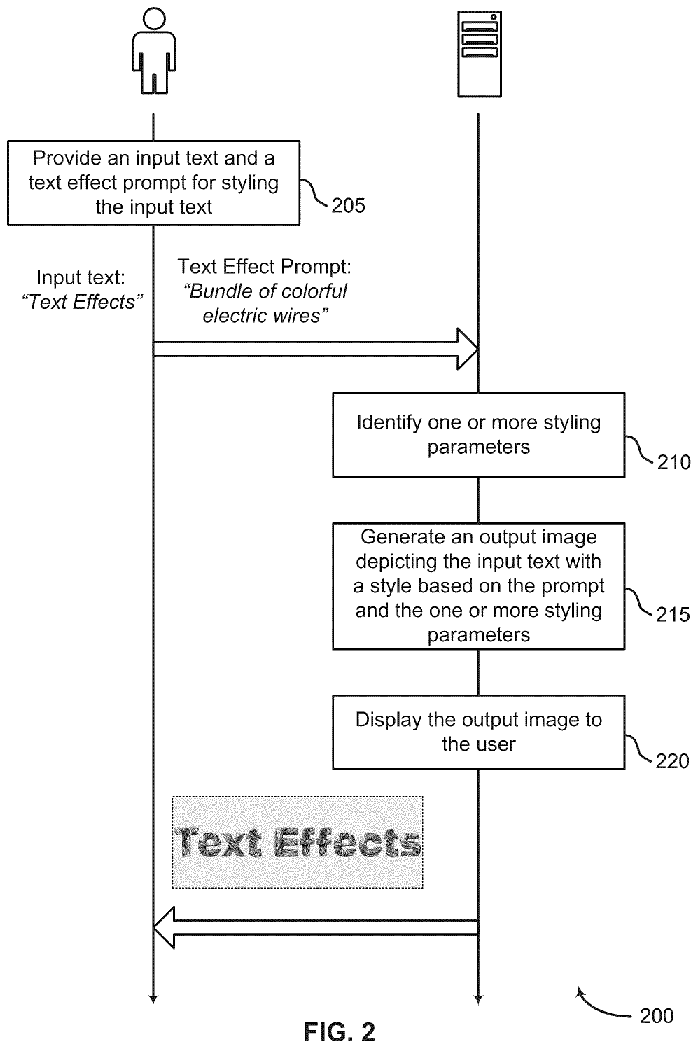

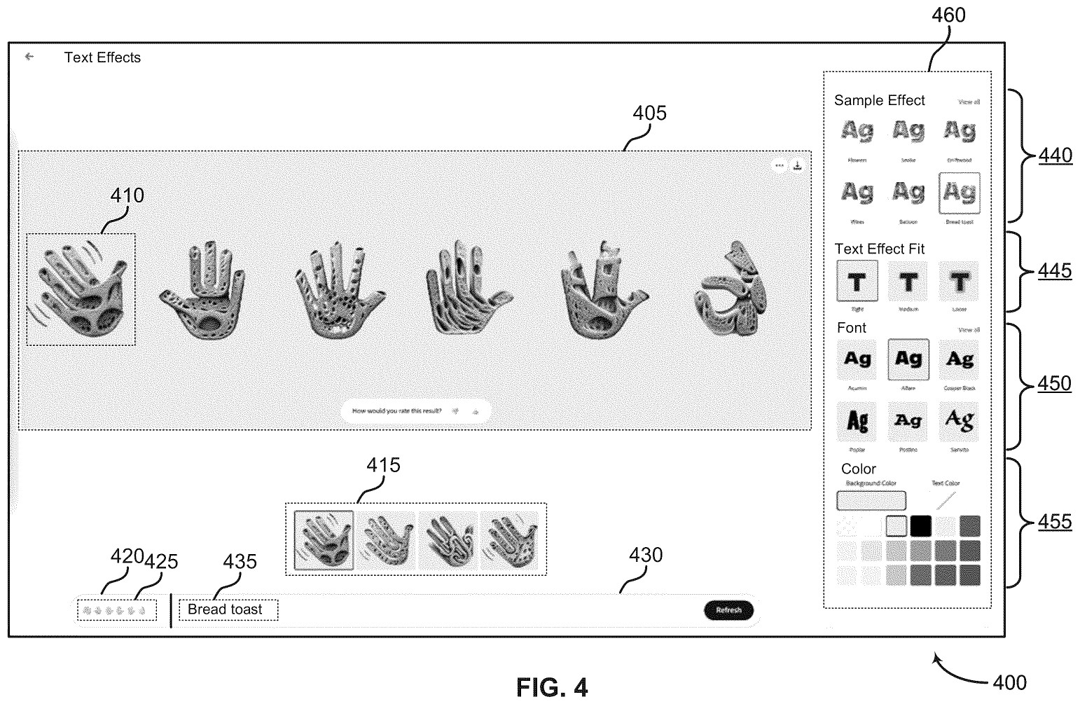

In another example, a sandwich shop owner wants to design a flyer to advertise a toasted bread sandwich. Applying text effect prompt “toasted bread” to an input text specifying the name of a sandwich using image processing apparatus 110, the sandwich shop owner can modify the name of the sandwich from plain text to a visually appealing brand name (see FIG. 4). The process of using image processing apparatus 110 is further described with reference to FIG. 2.

User device 105 may be a personal computer, laptop computer, mainframe computer, palmtop computer, personal assistant, mobile device, or any other suitable processing apparatus. In some examples, user device 105 includes software that incorporates an image processing application (e.g., an image editing application). In some examples, the image editing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a user interface may be represented in code which is sent to the user device 105 and rendered locally by a browser. In an embodiment, the user interface obtains an input text and a text effect prompt that describes a text effect for the input text. Greater detail regarding the user interface is described in FIGS. 3-5, 7 and 11.

Image processing apparatus 110 includes a computer implemented network comprising an image encoder, a content encoder, a style encoder, and an image generation model. Image processing apparatus 110 may also include a processor unit, a memory unit, an I/O module, and a training component. The training component is used to train a machine learning model (or an image processing network). Additionally, image processing apparatus 110 can communicate with database 120 via cloud 115. In some cases, the architecture of the image processing network is also referred to as a network, a machine learning model, or a network model. Further detail regarding the architecture of image processing apparatus 110 is provided with reference to FIGS. 8-12. Further detail regarding the operation of image processing apparatus 110 is provided with reference to FIGS. 2, 7, and 13.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user interacts with database controller. In other cases, database controller may operate automatically without user interaction.

FIG. 2 shows an example of a method 200 for image generation application according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the user provides an input text and a prompt for styling the input text. In some cases, the operations of this step refer to, or may be performed by, a user as described with reference to FIG. 1. As an example shown in FIG. 2, an input text is “Text Effects” comprising a total of eleven English letters or characters. A text effect prompt is “bundle of colorful electric wires” that describes a target text effect for the input text.

At operation 210, the system identifies one or more styling parameters. In some cases, the operations of this step refer to, or may be performed by, an image processing apparatus as described with reference to FIGS. 1 and 8. In some cases, the one or more styling parameters include a text effect fitness (i.e., a degree that the target text effect should respect the shape of the underlying font, e.g., “tight fit”, “medium fit”, “loose fit”), font, background color, text color, etc.

At operation 215, the system generates an output image depicting the input text with a style based on the prompt and the one or more styling parameters. In some cases, the operations of this step refer to, or may be performed by, an image processing apparatus as described with reference to FIGS. 1 and 8. In some cases, each letter or symbol (i.e., each “glyph”) of the text is generated separately, but style consistency is maintained by using a same style text embedding to guide the generation of each separate glyph.

At operation 220, the system displays the output image to the user. In some cases, the operations of this step refer to, or may be performed by, an image processing apparatus as described with reference to FIGS. 1 and 8. In the above example, the output image depicts the input text (i.e., “Text Effects”) with a text effect described by the text effect prompt (i.e., bundle of colorful electric wires). Each letter of “Text Effects” has a surface of bundles of colorful electric wires. The style of the letters are consistent but not identical.

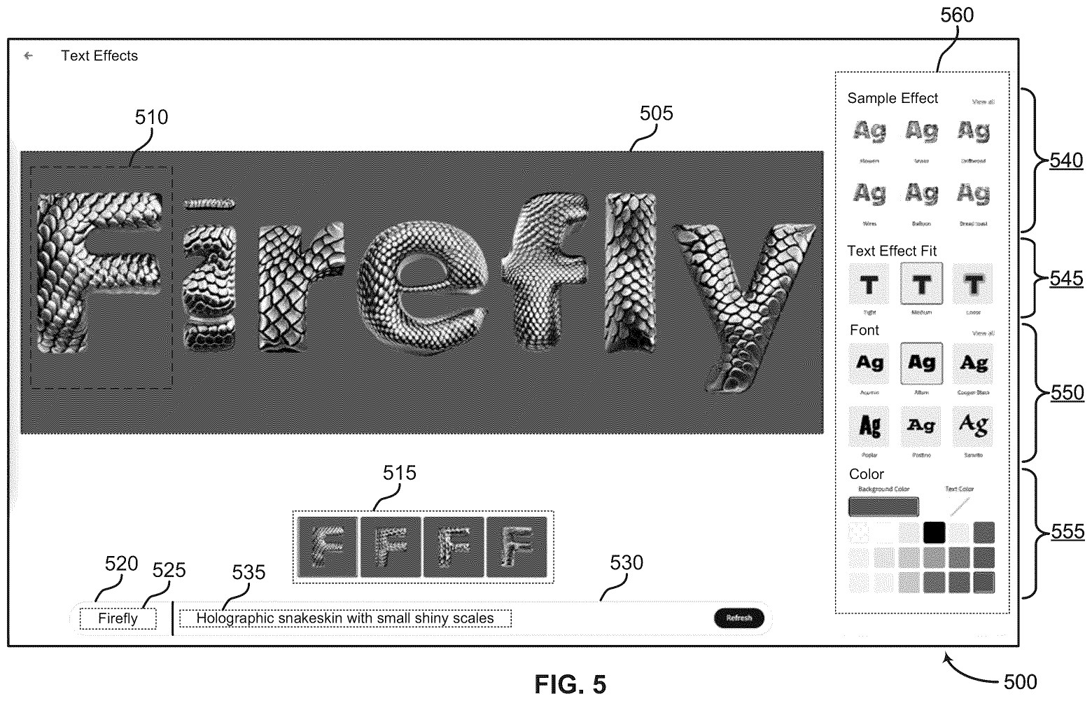

FIG. 3 shows an example of a first text effect according to aspects of the present disclosure. The example shown includes user interface 300, output image 305, character image 310, candidate character images 315, text interface 320, input text 325, prompt interface 330, text effect prompt 335, sample effect element 340, text effect fit element 345, font element 350, color element 355, and styling interface 360. User interface 300 is an example of, or includes aspects of, the corresponding element described with reference to FIGS. 4 and 5.

The first text effect in FIG. 3 shows an example in which the style “bundle of colorful electric wires” has been applied to the text “Text Effects”. User interface 300 includes text interface 320 and prompt interface 330. According to some embodiments, text interface 320 is configured to obtain an input text 325. Text interface 320 is an example of, or includes aspects of, the corresponding element described with reference to FIGS. 4, 5, 8, and 11.

According to some embodiments, prompt interface 330 is configured to obtain a text effect prompt 335 that describes a text effect for the input text 325. In some examples, the text effect prompt 335 includes a style tag and the style embedding is based on the style tag. Prompt interface 330 is an example of, or includes aspects of, the corresponding element described with reference to FIGS. 4, 5, 8, and 11. Input text 325 is an example of, or includes aspects of, the corresponding element described with reference to FIGS. 4 and 5. Text effect prompt 335 is an example of, or includes aspects of, the corresponding element described with reference to FIGS. 4 and 5.

In the example, input text 325 is “Text Effects”. Text effect prompt 335 is “bundle of colorful electric wires”. Output image 305, generated by an image generation model, depicts the input text 325 with the text effect described by the text effect prompt 335. The image generation model outputs candidate character images 315 for user selection. For example, the first candidate image of candidate character images 315 is selected. Output image 305 includes character image 310.

Output image 305 is an example of, or includes aspects of, the corresponding element described with reference to FIGS. 4-6, and 9. Character image 310 is an example of, or includes aspects of, the corresponding element described with reference to FIGS. 4-6. Candidate character images 315 are examples of, or include aspects of, the corresponding element described with reference to FIGS. 4 and 5.

According to some embodiments, styling interface 360 obtains one or more styling parameters, where output image 305 is generated based on the one or more styling parameters. Styling interface 360 includes at least sample effect element 340, text effect fit element 345, font element 350, and color element 355. The one or more styling parameters are based on user selection or interaction via the at least sample effect element 340, text effect fit element 345, font element 350, and color element 355. Styling interface 360 is an example of, or includes aspects of, the corresponding element described with reference to FIGS. 4, 5, 8, and 11.

In some examples, sample effect element 340 presents a set of sample effects such as flowers, snake, driftwood, wires, balloon, bread toast, etc. In the above example, a sample effect “wires” is selected. Sample effect element 340 is an example of, or includes aspects of, the corresponding element described with reference to FIGS. 4 and 5.

In some examples, text effect fit element 345 presents a set of text effect fit parameters including tight fit, medium fit, and loose fit. In the above example, “medium” is selected as text effect fit parameter. Text effect fit element 345 is an example of, or includes aspects of, the corresponding element described with reference to FIGS. 4 and 5.

In some examples, font element 350 presents a set of fonts such as Acumin, Alfarn, Cooper Black, Poplar, Postino, Sanvito, etc. In the above example, “Alfarn” font is selected. Font element 350 is an example of, or includes aspects of, the corresponding element described with reference to FIGS. 4 and 5.

In some examples, background color and text color can be set or adjusted via color element 355. In the above example, the background color for output image 305 is set to gray. Color element 355 is an example of, or includes aspects of, the corresponding element described with reference to FIGS. 4 and 5.

FIG. 4 shows an example of a second text effect according to aspects of the present disclosure. The example shown includes user interface 400, output image 405, character image 410, candidate character images 415, text interface 420, input text 425, prompt interface 430, text effect prompt 435, sample effect element 440, text effect fit element 445, font element 450, color element 455, and styling interface 460. User interface 400 is an example of, or includes aspects of, the corresponding element described with reference to FIGS. 3 and 5.

In an example of FIG. 4, the second text effect shows an example in which the style “bread toast” has been applied to a series of hand symbols. Here, input text 425 includes a series of hand symbols. Text effect prompt 435 is “bread toast”.

Output image 405 is an example of, or includes aspects of, the corresponding element described with reference to FIGS. 3, 5, 6, and 9. Character image 410 is an example of, or includes aspects of, the corresponding element described with reference to FIGS. 3, 5, and 6. Candidate character images 415 is an example of, or includes aspects of, the corresponding element described with reference to FIGS. 3 and 5.

In an embodiment, User interface 400 includes text interface 420, prompt interface 430, and styling interface 460. Text interface 420 is an example of, or includes aspects of, the corresponding element described with reference to FIGS. 3, 5, 8, and 11. Input text 425 is an example of, or includes aspects of, the corresponding element described with reference to FIGS. 3 and 5. Prompt interface 430 is an example of, or includes aspects of, the corresponding element described with reference to FIGS. 3, 5, 8, and 11. Text effect prompt 435 is an example of, or includes aspects of, the corresponding element described with reference to FIGS. 3 and 5. Styling interface 460 is an example of, or includes aspects of, the corresponding element described with reference to FIGS. 3, 5, 8, and 11.

In the example of FIG. 4, “bread toast” text effect is selected via sample effect element 440. Sample effect element 440 is an example of, or includes aspects of, the corresponding element described with reference to FIGS. 3 and 5.

In the above example, “tight” is selected for text effect fitness via text effect fit element 445. Text effect fit element 445 is an example of, or includes aspects of, the corresponding element described with reference to FIGS. 3 and 5.

In the above example, “Alfarn” font is selected for font element 450. Font element 450 is an example of, or includes aspects of, the corresponding element described with reference to FIGS. 3 and 5. Color element 455 is an example of, or includes aspects of, the corresponding element described with reference to FIGS. 3 and 5.

FIG. 5 shows an example of a third text effect according to aspects of the present disclosure. The example shown includes user interface 500, output image 505, character image 510, candidate character images 515, text interface 520, input text 525, prompt interface 530, text effect prompt 535, sample effect element 540, text effect fit element 545, font element 550, color element 555, and styling interface 560. User interface 500 is an example of, or includes aspects of, the corresponding element described with reference to FIGS. 3 and 4.

In an example of FIG. 5, the third text effect shows an example in which the style “holographic snakeskin with small shiny scales” has been applied to the text “Firefly”. Here, input text 525 is “Firefly”. Text effect prompt 535 is “holographic snakeskin with small shiny scales”.

Output image 505 is an example of, or includes aspects of, the corresponding element described with reference to FIGS. 3, 4, 6, and 9. Character image 510 is an example of, or includes aspects of, the corresponding element described with reference to FIGS. 3, 4, and 6. Candidate character images 515 is an example of, or includes aspects of, the corresponding element described with reference to FIGS. 3 and 4. Text interface 520 is an example of, or includes aspects of, the corresponding element described with reference to FIGS. 3, 4, 8, and 11. Input text 525 is an example of, or includes aspects of, the corresponding element described with reference to FIGS. 3 and 4. Prompt interface 530 is an example of, or includes aspects of, the corresponding element described with reference to FIGS. 3, 4, 8, and 11. Text effect prompt 535 is an example of, or includes aspects of, the corresponding element described with reference to FIGS. 3 and 4.

Styling interface 560 is an example of, or includes aspects of, the corresponding element described with reference to FIGS. 3, 4, 8, and 11. Sample effect element 540 is an example of, or includes aspects of, the corresponding element described with reference to FIGS. 3 and 4. Text effect fit element 545 is an example of, or includes aspects of, the corresponding element described with reference to FIGS. 3 and 4. Font element 550 is an example of, or includes aspects of, the corresponding element described with reference to FIGS. 3 and 4. Color element 555 is an example of, or includes aspects of, the corresponding element described with reference to FIGS. 3 and 4.

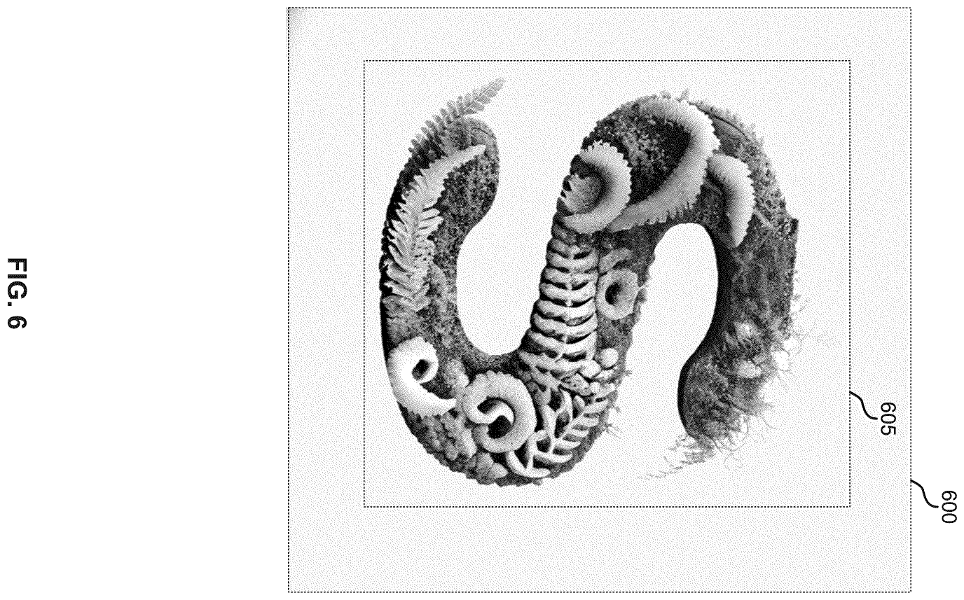

FIG. 6 shows an example of a fourth text effect according to aspects of the present disclosure. The example shown includes output image 600 and character image 605. The fourth text effect shows an example of the letter “S” that has been modified to include a texture including ferns and moss has been applied to a promotional document. In an example shown in FIG. 6, an input text is “S” and a text effect prompt relates to ferns and moss. Output image 600 includes character image 605 that depicts the input text with the text effect described by the text effect prompt.

Output image 600 is an example of, or includes aspects of, the corresponding element described with reference to FIGS. 3-5, and 9. Character image 605 is an example of, or includes aspects of, the corresponding element described with reference to FIGS. 3-5.

FIG. 7 shows an example of a method 700 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system obtains, via a user interface, an input text. In some cases, the operations of this step refer to, or may be performed by, a text interface as described with reference to FIGS. 3-5, 8, and 11. In some examples, a user interface includes a text interface and a prompt interface. In some examples, a user provides text (or symbols, etc.) and selects a font. A mask is generated based on the text in the selected font.

At operation 710, the system obtains, via the user interface, a text effect prompt that describes a text effect for the input text. In some cases, the operations of this step refer to, or may be performed by, a prompt interface as described with reference to FIGS. 3-5, 8, and 11.

In some embodiments, the text effect prompt includes or specifies a style prompt. The user provides a style prompt. The style prompt is then encoded to generate a text embedding. In some cases, the text embedding is converted to an image-like embedding (either in the same embedding space, or in a different embedding space). A diffusion model then generates an image based on the mask and the style text embedding.

In some cases, the style text prompt can be modified prior to being encoded. For example, some language may be added to ensure a more accurate text effect representation (i.e., using prompt engineering). Similarly, text can be modified or removed.

For example, the user can select a “tighter” or “looser” conformity to the glyph mask based on the selected font. The image for each glyph can be generated based on the selected parameter so that in some cases the generated image conforms precisely to the mask, and in other cases, the generated glyph extends somewhat beyond the mask region.

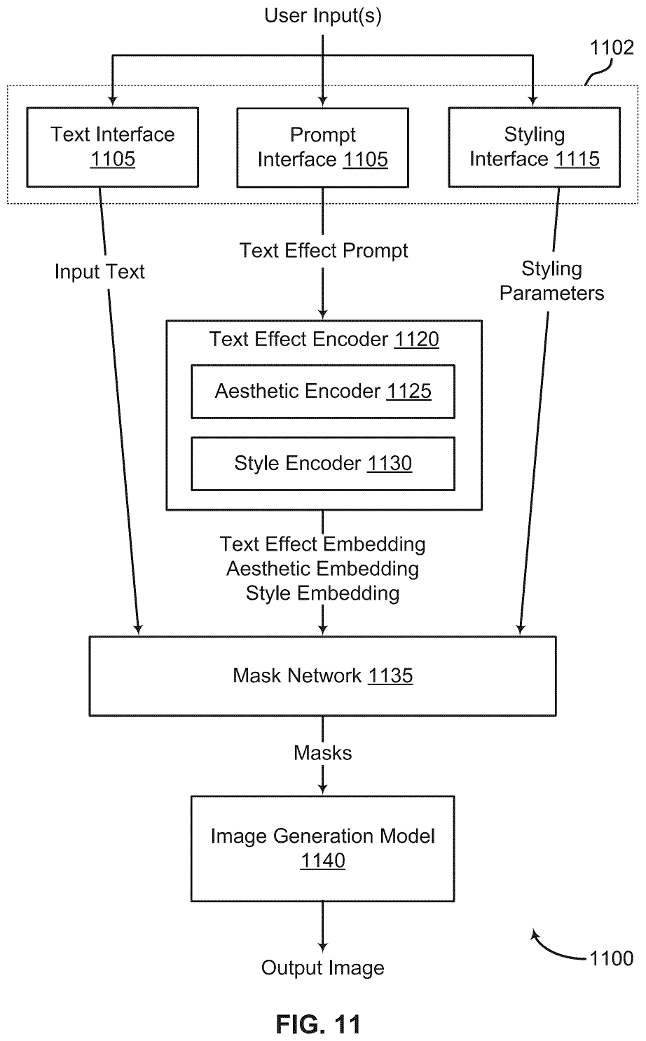

At operation 715, the system generates, by an image generation model, an output image depicting the input text with the text effect described by the text effect prompt. In some cases, the operations of this step refer to, or may be performed by, an image generation model as described with reference to FIGS. 8 and 11.

In some cases, each letter or symbol (i.e., each “glyph”) of the text is generated separately, but style consistency is maintained by using the same style text embedding to guide the generation of each separate glyph. The image generation network can be trained on both image embeddings and text captions.

During denoising, a flag can be used to indicate some steps that use the style text embedding as guidance and other steps that do not. For example, diffusion can be initially performed without the style embedding to ensure coherency to the provided text prompt. In some examples, later steps can use the style text embedding to ensure the desired texture is applied. Similarly, the diffusion sampling steps used can be more dense at the beginning of the process and less dense at the end of the process.

In some cases, a combination of methods may be used to ensure that the generated image for each glyph conforms to the shape of the mask, while in some cases allowing for some deviation from the precise shape of the mask. First, a noise image can be generated that is not completely random noise (e.g., using an SDEdit process). For example, an intermediate image from a forward diffusion process may be used so that the noise used to initialize the image generation process includes an indication of the shape of the foreground glyph. Additionally or alternatively, the mask can be used to determine the noise that is used or removed during intermediate diffusion steps (e.g., DiffEdit).

In some examples, a mask or transparency can be generated after the style is applied to the glyph. Since the generated image may not conform to the precise boundaries of the initial text font, it can be useful to determine the boundaries of the foreground after generation. To obtain the mask or transparency of the foreground, a combination of methods may be applied. For example, a subject selection method, an object selection method, or a color-based selection method may be used to identify and differentiate foreground and background pixels. In some cases, a single boundary selection method is used, and in some cases, a combination of methods is applied. A distance transform may also be used to generate or refine a glyph boundary mask.

The subject selection and the object selection methods may differ based on whether they snap to a boundary of the object, and the algorithm for determining the object. Embodiments of the disclosure use a combination of subject selection and object selection.

An Object Selection tool may be used to simplify the process of selecting an object or region in an image, including text, people, cars, pets, sky, water, buildings, mountains, and more. In some examples, a user can draw a rectangle or lasso around an object or region or let the Object Selection tool automatically detect and select an object or region within the image. Selections made with the Object Selection tool are now more precise and preserve details on the edges of the selection, which means you spend less time getting those perfect selections.

A Select Subject action may include a content-aware algorithm for selecting a subject of an image. In some cases, the Select Subject applies a custom algorithm when it detects a person or text in the image. The Select Subject command automatically selects the most prominent subject using advanced machine learning technology. The Select Subject algorithm can be trained to identify a variety of objects in an image in addition to text.

### Network Architecture

In FIGS. 8-12, an apparatus and method for image processing are described. One or more embodiments of the apparatus and method include at least one processor; at least one memory including instructions executable by the at least one processor; a text interface configured to obtain an input text; a prompt interface configured to obtain a text effect prompt that describes a text effect for the input text; and an image generation model comprising parameters stored in the at least one memory and trained to generate an output image depicting the input text with the text effect based on the text effect prompt.

In some examples, the image generation model comprises a diffusion model. Some examples of the apparatus and method further include a text effect encoder configured to encode the text effect prompt to obtain a text effect embedding, wherein the output image is generated based on the text effect embedding.

In some examples, the text effect encoder comprises an aesthetic encoder configured to generate an aesthetic embedding and a style encoder configured to generate a style embedding, wherein the output image is generated based on the aesthetic embedding and the style embedding. Some examples of the apparatus and method further include a mask network configured to generate a mask for each character of the input text.

FIG. 8 shows an example of an image processing apparatus 800 according to aspects of the present disclosure. The example shown includes image processing apparatus 800, processor unit 805, I/O module 810, training component 815, and memory unit 820. Image processing apparatus 800 is an example of, or includes aspects of, the corresponding element described with reference to FIG. 1. Machine learning model 825 is an example of, or includes aspects of, the corresponding element described with reference to FIG. 11. In one embodiment, machine learning model 825 includes text interface 830, prompt interface 835, styling interface 840, text effect encoder 845, mask network 850, and image generation model 855.

Processor unit 805 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor unit 805 is configured to operate a memory array using a memory controller. In other cases, a memory controller is integrated into the processor. In some cases, processor unit 805 is configured to execute computer-readable instructions stored in a memory to perform various functions. In some embodiments, processor unit 805 includes special purpose components for modem processing, baseband processing, digital signal processing, or transmission processing.

Examples of memory unit 820 include random access memory (RAM), read-only memory (ROM), or a hard disk. Examples of memory unit 820 include solid state memory and a hard disk drive. In some examples, memory unit 820 is used to store computer-readable, computer-executable software including instructions that, when executed, cause a processor to perform various functions described herein. In some cases, memory unit 820 contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within memory unit 820 store information in the form of a logical state.

In some examples, at least one memory unit 820 includes instructions executable by the at least one processor unit 805. Memory unit 820 includes machine learning model 825 or stores parameters of machine learning model 825.

I/O module 810 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 810 includes a user interface. A user interface may enable a user to interact with a device. In some embodiments, the user interface may include an audio device, such as an external speaker system, an external display device such as a display screen, or an input device (e.g., remote control device interfaced with the user interface directly or through an I/O controller module). In some cases, a user interface may be a graphical user interface (GUI). In some examples, a communication interface operates at the boundary between communicating entities and the channel and may also record and process communications. Communication interface is provided herein to enable a processing system coupled to a transceiver (e.g., a transmitter and/or a receiver). In some examples, the transceiver is configured to transmit (or send) and receive signals for a communications device via an antenna.

According to some embodiments of the present disclosure, image processing apparatus 800 includes a computer implemented artificial neural network (ANN). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

According to some embodiments, image processing apparatus 800 includes a convolutional neural network (CNN) for image processing (e.g., image encoding, image decoding). CNN is a class of neural networks that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

According to some aspects, training component 815 initializes an image generation model 855. In some examples, training component 815 receives training data including a training input text, a training image depicting the training input text, and a training text effect prompt that describes a text effect for the training input text. Training component 815 trains the image generation model 855 to generate an output image based on the mask, where the output image includes the text effect based on the training text effect prompt.

In some examples, training component 815 trains a mask network 850 to generate the mask for each character of the training input text, where the output image is generated based on the mask. In some examples, training component 815 trains a text effect encoder 845 to encode at least a portion of the training text effect prompt to obtain a text effect embedding, where the output image is generated based on the text effect embedding. In some examples, training component 815 trains a style encoder to encode at least a portion of the training text effect prompt to obtain a style embedding, where the output image is generated based on the style embedding. In some cases, training component 815 is implemented on an apparatus other than image processing apparatus 800.

In some embodiments, a user interface includes text interface 830 and prompt interface 835. The user interface obtains an input text and a text effect prompt that describes a text effect for the input text. Text interface 830 is an example of, or includes aspects of, the corresponding element described with reference to FIGS. 3-5, and 11. Prompt interface 835 is an example of, or includes aspects of, the corresponding element described with reference to FIGS. 3-5, and 11. Styling interface 840 is an example of, or includes aspects of, the corresponding element described with reference to FIGS. 3-5, and 11.

According to some embodiments, text effect encoder 845 encodes the text effect prompt to obtain a text effect embedding, where the output image is generated based on the text effect embedding. In some examples, text effect encoder 845 generates a style embedding and an aesthetic embedding based on the text effect prompt, where the output image is generated based on the style embedding and the aesthetic embedding.

In some examples, text effect encoder 845 identifies at least a portion of the text effect prompt as a negative text. Text effect encoder 845 encodes the negative text to obtain a negative text effect embedding, where the output image is generated based on the negative text effect embedding.

In some examples, the text effect encoder 845 includes an aesthetic encoder configured to generate an aesthetic embedding and a style encoder configured to generate a style embedding, where the output image is generated based on the aesthetic embedding and the style embedding. Text effect encoder 845 is an example of, or includes aspects of, the corresponding element described with reference to FIG. 11.

According to some embodiments, mask network 850 generates a mask for each character of the input text. Mask network 850 generates a mask for each character of the training input text. Mask network 850 is an example of, or includes aspects of, the corresponding element described with reference to FIG. 11.

According to some embodiments, image generation model 855 generates an output image depicting the input text with the text effect described by the text effect prompt. In some examples, image generation model 855 identifies a font for the input text, where the output image is generated based on the font. In some examples, image generation model 855 identifies a fit parameter that indicates a degree to which the output image adheres to a shape of the input text, where the output image is generated based on the fit parameter. In some examples, image generation model 855 identifies a background color, where the output image is generated based on the background color. In some examples, image generation model 855 identifies a text color, where the output image is generated based on the text color. In some examples, image generation model 855 generates a character image for each character of the input text based on the mask, where the output image includes the character image for each character of the input text.

According to some embodiments, image generation model 855 comprises parameters stored in the at least one memory and is trained to generate an output image depicting the input text with the text effect based on the text effect prompt. In some examples, the image generation model 855 includes a diffusion model. In some cases, image generation model 855 includes a pre-trained text-to-image generative model. Image generation model 855 is an example of, or includes aspects of, the corresponding element described with reference to FIG. 11.

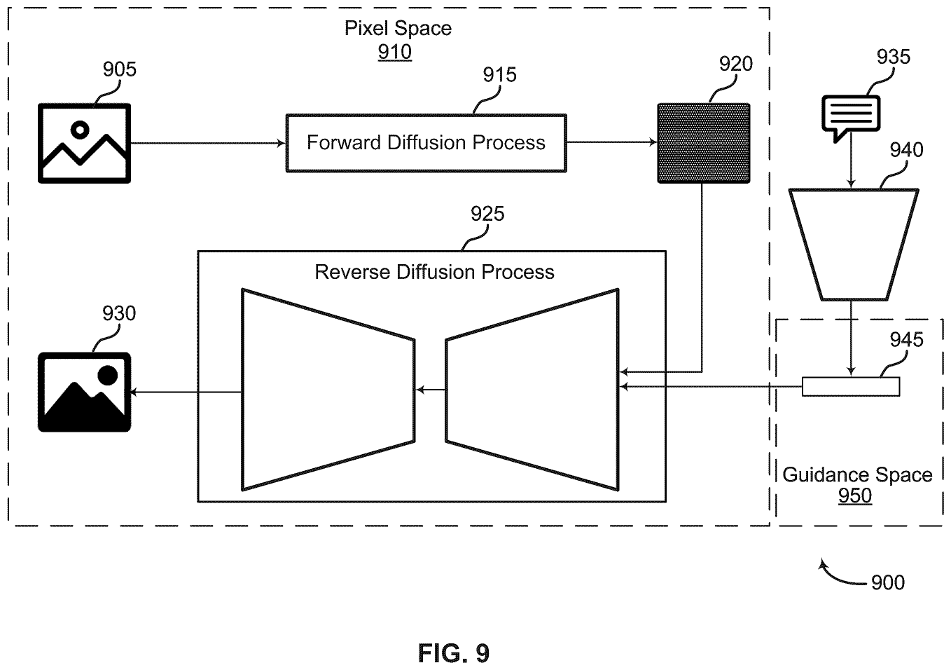

FIG. 9 shows an example of a guided diffusion model 900 according to aspects of the present disclosure. The example shown includes guided diffusion model 900, original image 905, pixel space 910, forward diffusion process 915, noisy images 920, reverse diffusion process 925, output image 930, text prompt 935, text encoder 940, guidance features 945, and guidance space 950. The guided diffusion model 900 is an example of, or includes aspects of, the corresponding element described with reference to FIG. 8 (see image generation model 855).

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Methods for operating diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided diffusion model 900 may take an original image 905 in a pixel space 910 as input and apply forward diffusion process 915 to gradually add noise to the original image 905 to obtain noisy images 920 at various noise levels.

Next, a reverse diffusion process 925 (e.g., a U-Net ANN) gradually removes the noise from the noisy images 920 at the various noise levels to obtain an output image 930. In some cases, an output image 930 is created from each of the various noise levels. The output image 930 can be compared to the original image 905 to train the reverse diffusion process 925.

The reverse diffusion process 925 can also be guided based on a text prompt 935, or another guidance prompt, such as an image, a layout, a segmentation map, etc. The text prompt 935 can be encoded using a text encoder 940 (e.g., a multimodal encoder) to obtain guidance features 945 in guidance space 950. The guidance features 945 can be combined with the noisy images 920 at one or more layers of the reverse diffusion process 925 to ensure that the output image 930 includes content described by the text prompt 935. For example, guidance features 945 can be combined with the noisy features using a cross-attention block within the reverse diffusion process 925.

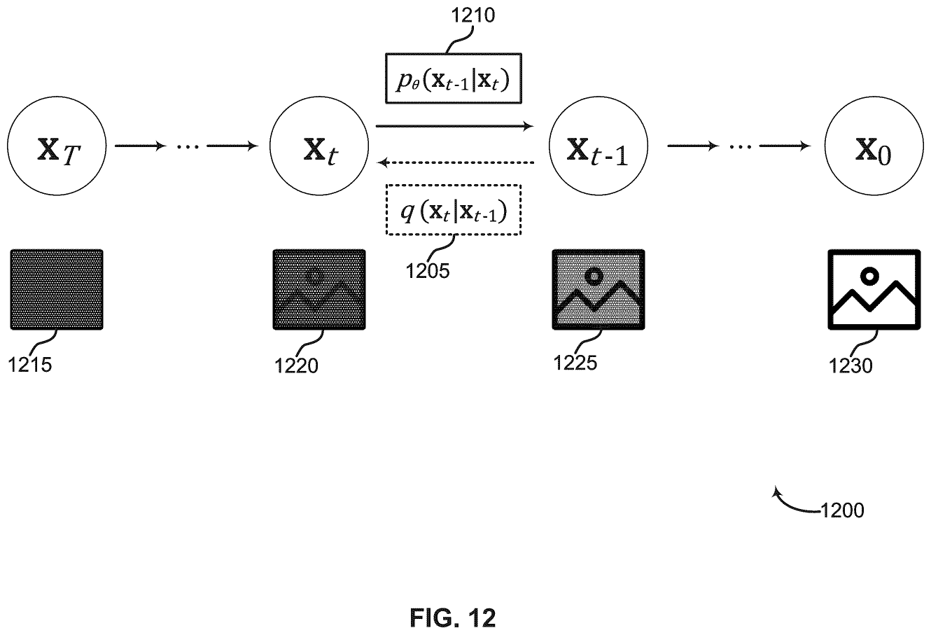

Original image 905 is an example of, or includes aspects of, the corresponding element described with reference to FIG. 12. Forward diffusion process 915 is an example of, or includes aspects of, the corresponding element described with reference to FIG. 12. Reverse diffusion process 925 is an example of, or includes aspects of, the corresponding element described with reference to FIG. 12. Output image 930 is an example of, or includes aspects of, the corresponding element described with reference to FIGS. 3-6.

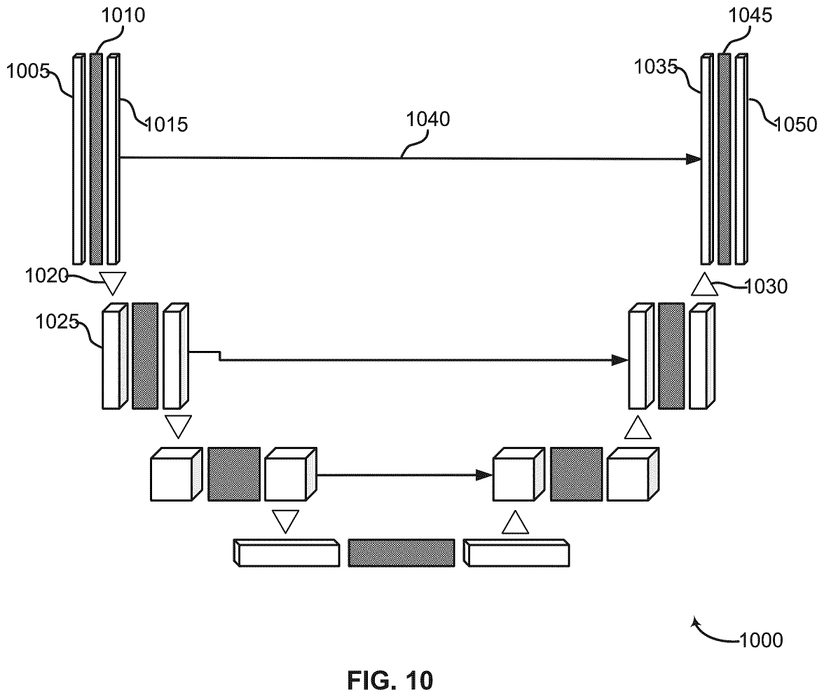

FIG. 10 shows an example of U-Net architecture according to aspects of the present disclosure. The example shown includes U-Net 1000, input features 1005, initial neural network layer 1010, intermediate features 1015, down-sampling layer 1020, down-sampled features 1025, up-sampling process 1030, up-sampled features 1035, skip connection 1040, final neural network layer 1045, and output features 1050.

In some examples, diffusion models are based on a neural network architecture known as a U-Net. The U-Net 1000 takes input features 1005 having an initial resolution and an initial number of channels, and processes the input features 1005 using an initial neural network layer 1010 (e.g., a convolutional network layer) to produce intermediate features 1015. The intermediate features 1015 are then down-sampled using a down-sampling layer 1020 such that down-sampled features 1025 features have a resolution less than the initial resolution and a number of channels greater than the initial number of channels.

This process is repeated multiple times, and then the process is reversed. That is, the down-sampled features 1025 are up-sampled using up-sampling process 1030 to obtain up-sampled features 1035. The up-sampled features 1035 can be combined with intermediate features 1015 having a same resolution and number of channels via a skip connection 1040. These inputs are processed using a final neural network layer 1045 to produce output features 1050. In some cases, the output features 1050 have the same resolution as the initial resolution and the same number of channels as the initial number of channels.

In some cases, U-Net 1000 takes additional input features to produce conditionally generated output. For example, the additional input features could include a vector representation of an input prompt. The additional input features can be combined with the intermediate features 1015 within the neural network at one or more layers. For example, a cross-attention module can be used to combine the additional input features and the intermediate features 1015.

FIG. 11 shows an example of a machine learning model 1100 according to aspects of the present disclosure. The example shown includes machine learning model 1100, user interface 1102, text interface 1105, prompt interface 1110, styling interface 1115, text effect encoder 1120, mask network 1135, and image generation model 1140. Machine learning model 1100 is an example of, or includes aspects of, the corresponding element described with reference to FIG. 8. In some examples, user interface 1102 includes text interface 1105, prompt interface 1110, and styling interface 1115.

In some embodiments, text interface 1105 obtains an input text. Text interface 1105 is an example of, or includes aspects of, the corresponding element described with reference to FIGS. 3-5, and 8. Prompt interface 1110 obtains a text effect prompt. Prompt interface 1110 is an example of, or includes aspects of, the corresponding element described with reference to FIGS. 3-5, and 8. Styling interface 1115 obtains one or more styling parameters. Styling interface 1115 is an example of, or includes aspects of, the corresponding element described with reference to FIGS. 3-5, and 8.

In some embodiments, text effect encoder 1120 is configured to encode the text effect prompt to obtain a text effect embedding. For example, input text is “ABC” and text effect prompt is pebble [style=watercolor & black and white, avoid=yellow]. Herein, the text effect prompt includes a description of style (i.e., “pebble”), an aesthetic prompt (“style=watercolor & black and white”), and a negative prompt (“avoid=yellow”). In some cases, a same encoder is used to encode the description of style and the negative prompt while a separate encoder is used to encode the aesthetic prompt.

In some embodiments, text effect encoder 1120 includes an aesthetic encoder 1125 configured to generate an aesthetic embedding and a style encoder 1130 configured to generate a style embedding, wherein the output image is generated based on the aesthetic embedding and the style embedding. Text effect encoder 1120 is an example of, or includes aspects of, the corresponding element described with reference to FIG. 8.

Mask network 1135 is configured to generate a mask for each character of the input text. Mask network 1135 is an example of, or includes aspects of, the corresponding element described with reference to FIG. 8.

Image generation model 1140 generates an output image depicting the input text with the text effect described by the text effect prompt. Image generation model 1140 is an example of, or includes aspects of, the corresponding element described with reference to FIG. 8.

FIG. 12 shows an example of diffusion process 1200 according to aspects of the present disclosure. The example shown includes diffusion process 1200, forward diffusion process 1205, reverse diffusion process 1210, noisy image 1215, first intermediate image 1220, second intermediate image 1225, and original image 1230.

As described above with reference to FIG. 9, a diffusion model can include both a forward diffusion process 1205 for adding noise to an image (or features in a latent space) and a reverse diffusion process 1210 for denoising the images (or features) to obtain a denoised image. The forward diffusion process 1205 can be represented as q (xₜ|xₜ₋₁), and the reverse diffusion process 1210 can be represented as p (xₜ₋₁|xₜ). In some cases, the forward diffusion process 1205 is used during training to generate images with successively greater noise, and a neural network is trained to perform the reverse diffusion process 1210 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q (x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1210, the model begins with noisy data x_{T}, such as a noisy image 1215 and denoises the data to obtain the p (xₜ₋₁|xₜ). At each step t−1, the reverse diffusion process 1210 takes xₜ, such as first intermediate image 1220, and t as input. Here, t represents a step in the sequence of transitions associated with different noise levels, The reverse diffusion process 1210 outputs xₜ₋₁, such as second intermediate image 1225 iteratively until x_{T} is reverted back to x₀, the original image 1230. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T};0,1) is the pure noise distribution as the reverse process takes the outcome of the forward process, a sample of pure noise, as input and Πₜ₌₁^{T} p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space as input, and a generated data \tilde{x} is mapped back into the pixel space from the latent space as output. In some examples, x₀ represents an original input image with low image quality, latent variables x₁, . . . , x_{T} represent noisy images, and x represents the generated image with high image quality.

Forward diffusion process 1205 is an example of, or includes aspects of, the corresponding element described with reference to FIG. 9. Reverse diffusion process 1210 is an example of, or includes aspects of, the corresponding element described with reference to FIG. 9. Original image 1230 is an example of, or includes aspects of, the corresponding element described with reference to FIG. 9.

### Text Effect Generation Process

FIG. 13 shows an example of a method 1300 a text effect generation process according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the user provides an input text. In some cases, the operations of this step refer to, or may be performed by, a text interface as described with reference to FIGS. 3-5, 8, and 11. In some examples, an input text is transmitted to the machine learning model via a text interface. The input text is “Text Effects” as an example shown in FIG. 3. Users can type out “Text Effects” via the text interface.

At operation 1310, the user selects a font type. In some cases, the operations of this step refer to, or may be performed by, a styling interface as described with reference to FIGS. 3-5, 8, and 11. In some cases, selecting font type is performed prior to typing out input text.

At operation 1315, the user selects a fit parameter. In some cases, the operations of this step refer to, or may be performed by, a styling interface as described with reference to FIGS. 3-5, 8, and 11. In some examples, users select how strongly the text effects should respect the shape of the underlying font. The three settings are “tight”, “medium”, “loose”.

At operation 1320, the user sets a background color. In some cases, the operations of this step refer to, or may be performed by, a styling interface as described with reference to FIGS. 3-5, 8, and 11. In some examples, the user sets the background color to a single color or transparent.

At operation 1325, the user sets a text color. In some cases, the operations of this step refer to, or may be performed by, a styling interface as described with reference to FIGS. 3-5, 8, and 11. In some examples, the user sets the color of the input text to mildly influence the color of the generated image.

At operation 1330, the user provides a text effect prompt. In some cases, the operations of this step refer to, or may be performed by, a prompt interface as described with reference to FIGS. 3-5, 8, and 11. In some examples, users type a text effect prompt that describes the styling to be applied to the input text. The text effect prompt is “bundle of colorful electric wires”.

At operation 1335, the system generates an output image depicting the input text based on the text effect prompt and the one or more styling parameters. In some cases, the operations of this step refer to, or may be performed by, an image generation model as described with reference to FIGS. 8 and 11. The text effect is applied to the input text. The output image includes one or more character images. Characters of the input text share a similar style but the character styles are not identical (e.g., minor variations among the characters in terms of style). The output image can be downloaded to be imported into a project.

### Training and Evaluation

In FIGS. 14-15, a method, apparatus, and non-transitory computer readable medium for image processing are described. One or more embodiments of the method, apparatus, and non-transitory computer readable medium include initializing an image generation model; receiving training data including a training input text, a training image depicting the training input text, and a training text effect prompt that describes a text effect for the training input text; generating a mask for each character of the training input text; and training the image generation model to generate an output image based on the mask, wherein the output image comprises the text effect based on the training text effect prompt.

Some examples of the method, apparatus, and non-transitory computer readable medium further include training a mask network to generate the mask for each character of the training input text, wherein the output image is generated based on the mask.

Some examples of the method, apparatus, and non-transitory computer readable medium further include training a text effect encoder to encode at least a portion of the training text effect prompt to obtain a text effect embedding, wherein the output image is generated based on the text effect embedding.

Some examples of the method, apparatus, and non-transitory computer readable medium further include training a style encoder to encode at least a portion of the training text effect prompt to obtain a style embedding, wherein the output image is generated based on the style embedding.

FIG. 14 shows an example of a method 1400 for training a diffusion model via forward and reverse diffusion according to aspects of the present disclosure. The method 1400 represents an example of training a reverse diffusion process as described above with reference to FIG. 12. In some examples, these operations are performed by a system including a processor executing a set of codes to control functional elements of an apparatus, such as the image processing apparatus 800 described in FIG. 8.

Additionally or alternatively, certain processes of method 1400 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1405, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1410, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1415, the system at each stage n, starting with stage N, a reverse diffusion process is used to predict the image or image features at stage n-1. For example, the reverse diffusion process can predict the noise that was added by the forward diffusion process, and the predicted noise can be removed from the image to obtain the predicted image. In some cases, an original image is predicted at each stage of the training process.

At operation 1420, the system compares predicted image (or image features) at stage n−1 to an actual image (or image features), such as the image at stage n−1 or the original input image. For example, given observed data x, the diffusion model may be trained to minimize the variational upper bound of the negative log-likelihood—logp_{θ}(x) of the training data.

At operation 1425, the system updates parameters of the model based on the comparison. For example, parameters of a U-Net may be updated using gradient descent. Time-dependent parameters of the Gaussian transitions can also be learned.

FIG. 15 shows an example of a method 1500 for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Supervised learning is one of three basic machine learning paradigms, alongside unsupervised learning and reinforcement learning. Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

Accordingly, during the training process, the parameters and weights of the machine learning model are adjusted to increase the accuracy of the result (i.e., by attempting to minimize a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

At operation 1505, the system initializes an image generation model. In some cases, the operations of this step refer to, or may be performed by, a training component as described with reference to FIG. 8.

At operation 1510, the system receives training data including a training input text, a training image depicting the training input text, and a training text effect prompt that describes a text effect for the training input text. In some cases, the operations of this step refer to, or may be performed by, a training component as described with reference to FIG. 8.

At operation 1515, the system generates a mask for each character of the training input text. In some cases, the operations of this step refer to, or may be performed by, a mask network as described with reference to FIGS. 8 and 11.

At operation 1520, the system trains the image generation model to generate an output image based on the mask, where the output image includes the text effect based on the training text effect prompt. In some cases, the operations of this step refer to, or may be performed by, a training component as described with reference to FIG. 8.

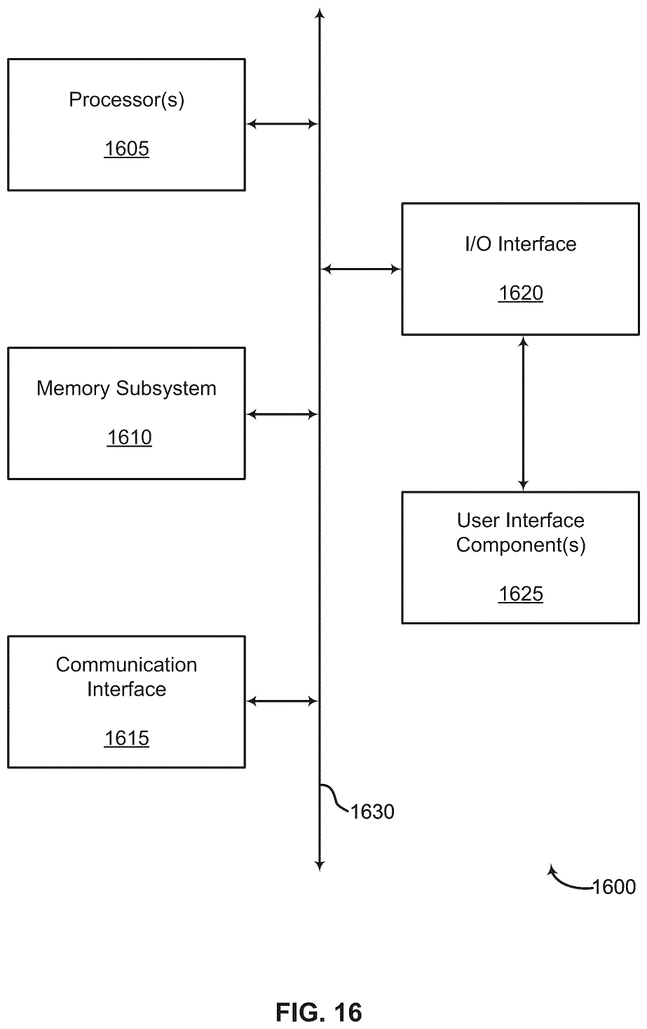

FIG. 16 shows an example of a computing device 1600 according to aspects of the present disclosure. The example shown includes computing device 1600, processor(s), memory subsystem 1610, communication interface 1615, I/O interface 1620, user interface component(s) 1625, and channel 1630. In one embodiment, computing device 1600 includes processor(s) 1605, memory subsystem 1610, communication interface 1615, I/O interface 1620, user interface component(s) 1625, and channel 1630.

In some embodiments, computing device 1600 is an example of, or includes aspects of, image processing apparatus 110 of FIG. 1. In some embodiments, computing device 1600 includes one or more processors 1605 that can execute instructions stored in memory subsystem 1610 to obtain, via a text interface, an input text; obtain, via a prompt interface, a text effect prompt that describes a text effect for the input text; and generate, by an image generation model, an output image depicting the input text with the text effect described by the text effect prompt.

According to some embodiments, computing device 1600 includes one or more processors 1605. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some embodiments, memory subsystem 1610 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some embodiments, communication interface 1615 operates at a boundary between communicating entities (such as computing device 1600, one or more user devices, a cloud, and one or more databases) and channel 1630 and can record and process communications. In some cases, communication interface 1615 is provided to enable a processing system coupled to a transceiver (e.g., a transmitter and/or a receiver). In some examples, the transceiver is configured to transmit (or send) and receive signals for a communications device via an antenna.

According to some embodiments, I/O interface 1620 is controlled by an I/O controller to manage input and output signals for computing device 1600. In some cases, I/O interface 1620 manages peripherals not integrated into computing device 1600. In some cases, I/O interface 1620 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1620 or via hardware components controlled by the I/O controller.

According to some embodiments, user interface component(s) 1625 enable a user to interact with computing device 1600. In some cases, user interface component(s) 1625 include an audio device, such as an external speaker system, an external display device such as a display screen, an input device (e.g., a remote control device interfaced with a user interface directly or through the I/O controller), or a combination thereof. In some cases, user interface component(s) 1625 include a GUI.

Performance of apparatus, systems and methods of the present disclosure have been evaluated, and results indicate embodiments of the present disclosure have obtained increased performance over existing technology. Example experiments demonstrate that the image processing apparatus outperforms conventional systems.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining, via a user interface, an input text;
obtaining, via the user interface, a text effect prompt that describes a text effect for the input text; and
generating, by an image generation model, an output image depicting the input text with the text effect described by the text effect prompt.

2. The method of claim 1, further comprising:
identifying a font for the input text, wherein the output image is generated based on the font.

3. The method of claim 1, further comprising:
identifying a fit parameter that indicates a degree to which the output image adheres to a shape of the input text, wherein the output image is generated based on the fit parameter.

4. The method of claim 1, further comprising:
identifying a background color, wherein the output image is generated based on the background color.

5. The method of claim 1, further comprising:
identifying a text color, wherein the output image is generated based on the text color.

6. The method of claim 1, further comprising:
generating a mask for each character of the input text; and
generating a character image for each character of the input text based on the mask, wherein the output image includes the character image for each character of the input text.

7. The method of claim 1, further comprising:
encoding the text effect prompt to obtain a text effect embedding, wherein the output image is generated based on the text effect embedding.

8. The method of claim 1, further comprising:
obtaining, via a styling interface, one or more styling parameters, wherein the output image is generated based on the one or more styling parameters.

9. The method of claim 1, further comprising:
generating a style embedding and an aesthetic embedding based on the text effect prompt, wherein the output image is generated based on the style embedding and the aesthetic embedding.

10. The method of claim 9, wherein:
the text effect prompt comprises a style tag and the style embedding is based on the style tag.

11. The method of claim 1, further comprising:
identifying at least a portion of the text effect prompt as a negative text; and
encoding the negative text to obtain a negative text effect embedding, wherein the output image is generated based on the negative text effect embedding.

12. A method comprising:
initializing an image generation model;
receiving training data including a training input text, a training image depicting the training input text, and a training text effect prompt that describes a text effect for the training input text;
generating a mask for each character of the training input text; and
training the image generation model to generate an output image based on the mask, wherein the output image comprises the text effect based on the training text effect prompt.

13. The method of claim 12, further comprising:
training a mask network to generate the mask for each character of the training input text, wherein the output image is generated based on the mask.

14. The method of claim 12, further comprising:
training a text effect encoder to encode at least a portion of the training text effect prompt to obtain a text effect embedding, wherein the output image is generated based on the text effect embedding.

15. The method of claim 12, further comprising:
training a style encoder to encode at least a portion of the training text effect prompt to obtain a style embedding, wherein the output image is generated based on the style embedding.

16. An apparatus comprising:
at least one processor;
at least one memory including instructions executable by the at least one processor;
a user interface configured to obtain an input text and a text effect prompt that describes a text effect for the input text; and
an image generation model comprising parameters stored in the at least one memory and trained to generate an output image depicting the input text with the text effect based on the text effect prompt.

17. The apparatus of claim 16, wherein:
the image generation model comprises a diffusion model.

18. The apparatus of claim 16, further comprising:
a text effect encoder configured to encode the text effect prompt to obtain a text effect embedding, wherein the output image is generated based on the text effect embedding.

19. The apparatus of claim 18, wherein:
the text effect encoder comprises an aesthetic encoder configured to generate an aesthetic embedding and a style encoder configured to generate a style embedding, wherein the output image is generated based on the aesthetic embedding and the style embedding.

20. The apparatus of claim 16, further comprising:
a mask network configured to generate a mask for each character of the input text.
